(19) United States
(12) Patent Application Publication
(10) Pub. No.: US 2008/0034937 A1
(43) Pub. Date: Feb. 14, 2008

(54) Foldover partial cutout punch

(76) Inventors: Ronald Aniceto, Hawthorne, NJ (US); Amy Jane Reda, Piscataway, NJ (US)

Correspondence Address: SOFER & HAROUN LLP., 317 MADISON AVENUE, SUITE 910, NEW YORK, NY, 10017, US

(21) Appl. No.: 11/503,665

(22) Filed: Aug. 14, 2006

(51) Int. Cl. B26D 5/08

(52) U.S. Cl. 83/588; 83/633; 83/684

(57) ABSTRACT

A punch device for producing a partial cutout in a sheet medium capable of being folded over an axis of symmetry for a unique decorative effect is disclosed. The punch includes a seat body formed with a horizontal fissure and a vertical chamber communicated with the fissure. A cutting block is disposed in the chamber. One face of the cutting block is disposed with a cutter, while the other face of the cutting block is disposed with a channel passing through the cutting block. A pressing lever is pivotally disposed in the channel of the cutting block. In use, a paper or a sheet is pushed into the fissure of the seat body and then the pressing section of the pressing lever is depressed to force the cutting block downward with the die punching the paper or the sheet placed in the fissure. The sheet is perforated along half of an outline of a geometric shape or a design, such that the interior portion circumscribed by the perforation can be folded over the shape's axis of symmetry for a unique effect. The folded over partial cutout creates the effect of the entire outline of the shape, with one half of the interior being completely cut out and the other half slightly raised from the surface of the sheet.

### FIELD OF THE INVENTION

The present inventions relates to a punch device capable of making a decorative partial cutout in a sheet medium.

### BACKGROUND OF THE INVENTION

In the field of decorative crafts such as scrapbooking, one desired design is to obtain a sheet is perforated along-half of an outline of a geometric shape or a design, such that the interior portion circumscribed by the perforation can be folded over the shape's axis of symmetry for a unique effect. The folded over partial cutout creates the effect of the entire outline of the shape, with one half of the interior being completely cut out and the other half slightly raised from the surface of the sheet.

However, creating such an effect without the use of the present invention is a difficult process, requiring great skill in the use of hand blades such as an X-ACTO® knife to make the necessary incisions in the plane of the sheet medium without cutting through the surrounding area. Furthermore, following the precise outline of anything but the most basic of shapes is extremely difficult and time consuming by hand, which explains the lack of such fold over partial cutout designs in the prior art.

### SUMMARY OF THE INVENTION

It is therefore a primary object of the present invention to provide a punch device including a seat body formed with a horizontal fissure and a vertical chamber communicated with the fissure. A cutting block is disposed in the chamber. One face of the cutting block is disposed with a cutter, while the other face of the cutting block is disposed with a channel passing through the cutting block. A pressing lever is pivotally disposed in the channel of the cutting block. A housing covers the seat body and is formed with a window for a pressing section of the pressing lever to extend therethrough. In use, a paper or a sheet is pushed into the fissure of the seat body and then the pressing section of the pressing lever is depressed to force the cutting block downward with the die punching the paper-or the sheet placed in the fissure. Therefore, a partial cutout of a design is created in the sheet medium.

It is a further object of the present invention to provide the above punch device, in which a resilient member is fitted under the cutting block in the chamber of the seat body. After the cutting block is released from the pressing force of the pressing lever, the resilient member serves to restore the cutting block to its home position.

It is still a further object of the present invention to provide the above punch device in which the cutting block is replaceably placed in the seat body, whereby the cutting block can be easily replaced by another cutting block to manufacture different products.

The present invention can be best understood through the following description and accompanying drawings, wherein:

### BRIEF DESCRIPTION OF THE DRAWINGS

FIG. 1 is a perspective exploded view of the present invention;

FIG. 2 is a perspective assembled view of the present invention;

FIG. 3 is a front sectional view of the present invention, wherein the pressing lever is not pressed downward;

FIG. 4 is a side sectional view of the present invention, wherein the pressing lever is not pressed downward;

FIG. 5 is a side sectional view according to FIG. 4, wherein the pressing lever is pressed downward to punch the paper or the sheet;

FIG. 6 is a top-down view of the underside of cutting block 20;

FIG. 7 is an overhead view of female die 14;

FIG. 8 is an overhead view of the sheet medium prior to use by the present invention;

FIG. 9 is an overhead view of the sheet medium after use by the present invention depicting how the partial cutout can be folded for decorative effect;

FIG. 10 shows an alternate embodiment in which one partial cutout can be embedded within the perimeter of another for an enhanced decorative effect; and

FIG. 11 shows another alternate embodiment in which two partial cutouts can be embedded within another with multiple concentric folding regions.

### DETAILED DESCRIPTION OF THE PREFERRED EMBODIMENT

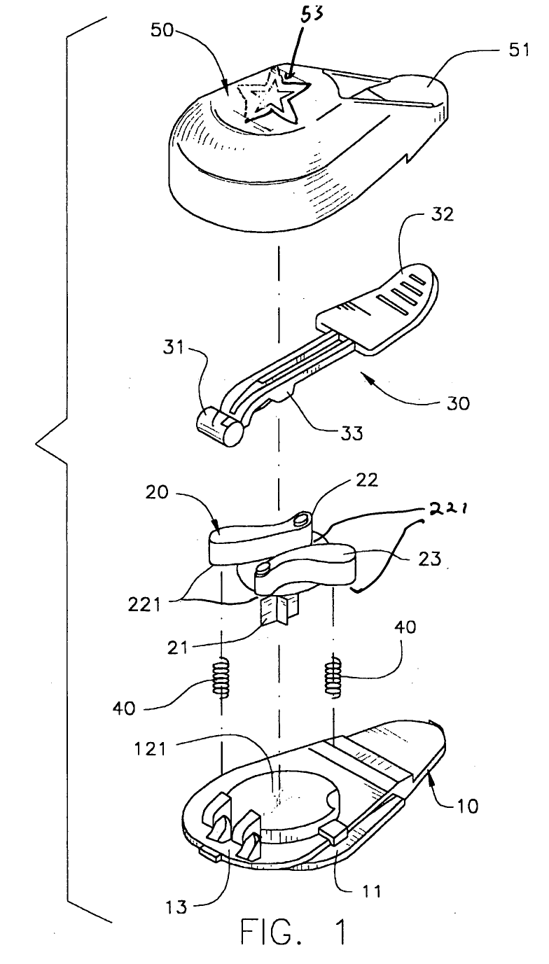

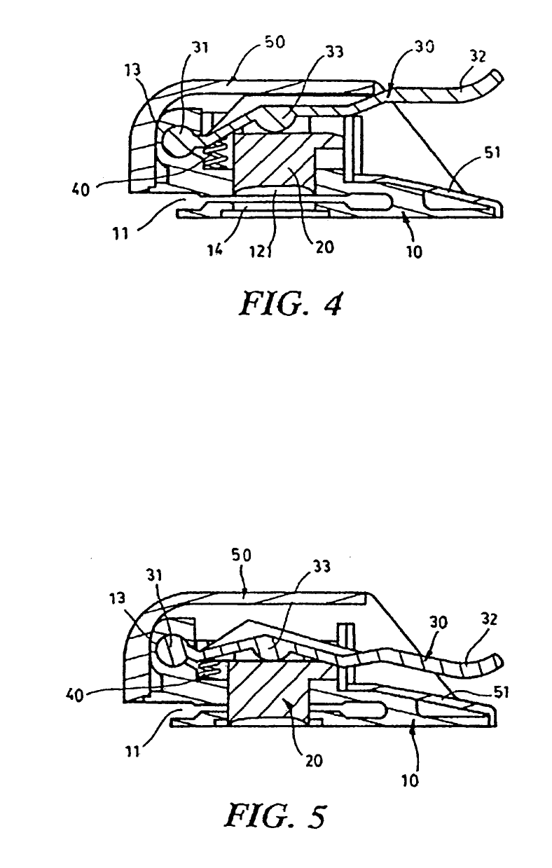

Please refer to FIGS. 1 to 5. The punch device of the present invention includes a seat body 10 formed with a horizontal fissure 11 at one end and a vertical chamber 12. The bottom of the chamber 12 is formed with an opening 121 communicated with the fissure 11. An insertion cavity 13 is disposed on seat body 10 in front of opening 121. The bottom of the seat body 10 is formed with a female die 14 communicated with the fissure 11 opposite to the opening 121.

A cutting block 20 is disposed on the seat body 10. One face of the cutting block 20 facing the fissure 11 is disposed with a solid cutter 21 in the shape of half of an outline of a geometric or other symmetrical shape. The other face of the cutting block 20 is disposed with a channel passing through the cutting block 20, forming walls 22 and 23.

The cutting block 20 is disposed with a projection 23 corresponding to the extension 122 to be fitted therein. A recess 221 is created on the underside of each of the protrusions of walls 22 and 23 for the purpose of engaging with resilient member 40, as described below.

A pressing lever 30 is disposed in the cutting block 20. One end of the pressing lever 30 is disposed with a pivot shaft 31 for rotatably inserting in the insertion cavity 13 of the seat body 10, whereby the pressing lever 30 is pivotally disposed on the seat body 10. The other end of the pressing lever 30 is disposed with an upward bent pressing section 32. In a addition, the pressing lever 30 is formed with a protuberance 33 extending in a direction reverse to that of the pressing section 32 for fitting in the recesses 221 of the cutting block 20.

At least one resilient member 40 is fitted into recess 221. As illustrated in FIG. 1 preferably two resilient members 40 where at least one resilient member 40 comprises first and second oppositely disposed springs adjacent to said die. The first resilient member 40 is disposed along a second axis and the second resilient member 40 disposed along a third axis, the third axis spaced apart from the first solid cutter 21 axis and the second resilient member 40 axis.

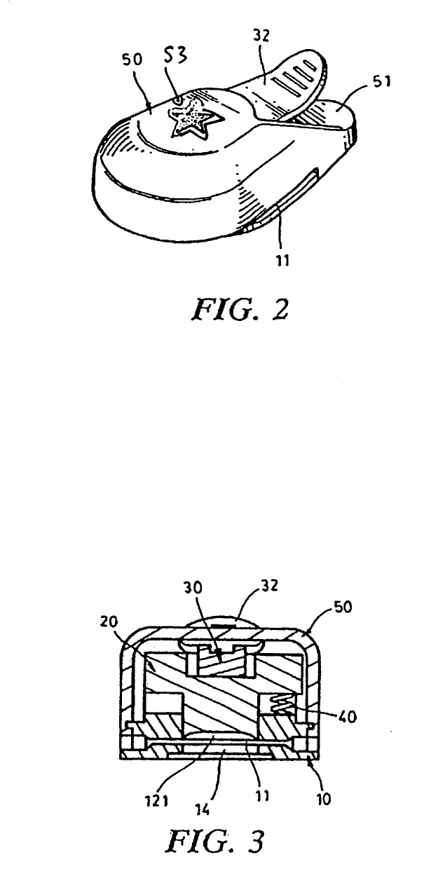

A housing 50 covers the seat body 10 and is formed with a window 51, whereby the pressing section 32 of the pressing lever 30 can extends through the window 51 out of the housing 50. As illustrated in FIGS. 1 and 2, housing 50 preferably maintains an indication 53 corresponding to the shape of cutter 21.

In use, a paper or a sheet 60 is horizontally placed in the fissure 11 of the seat body 10 and pushed inward to a true position. Fissure 11 is maintained perpendicular to the movement axis of cutter 21. Then the pressing section 32 of the pressing lever 30 is pivotally depressed about the pivot shaft 31, whereby the protuberance 33 of the pressing lever 30 is moved downward to exert a force onto the cutting block 20. Accordingly, the cutting block 20 is forced downward with the cutter 21 passing through the opening 121 of the chamber 12 to punch the paper or the sheet placed in the fissure 11 through the correspondingly shaped die 14. Thus, a perforation is created in the sheet medium as defined by the outer periphery of the cutter 21 which engages with the female die 14 as shown in FIG. 5 The resilient member 40 serves to restore the cutting block 20 to its home position. At this time, the pressing section 32 of the pressing lever 30 is moved upward along with the cutting block 20 to its home position. The above operation can be repeatedly performed to create the same partial cutout.

As shown in FIG. 6, Cutter 21 is ideally a sharpened tapered metal blade, shaped as a three dimensional projection of the outline to be created. Since the object of the present invention is to create a partial outline, the blade only consists of the portion necessary to perforate half of the outline of the desired shape, as defined by an axis of symmetry 61. A support protrusion 25 may also be placed on the cutting block 20 on the same side, and adjacent to, cutter 21. This protrusion 25 does not engage with die 14, and is designed to prevent wrinkling or warping in the sheet medium.

In one embodiment of the present invention, cutter 21 is tapered such that its highest point is furthest away from the axis of symmetry 61 and its lowest point is along the line that defines the axis of symmetry 61. In an alternate embodiment, the edge on cutter 21 can be serrated. Both approaches are designed to make the perforations for the partial cutouts as cleanly as possible, without any wrinkling or warping in the sheet medium 60.

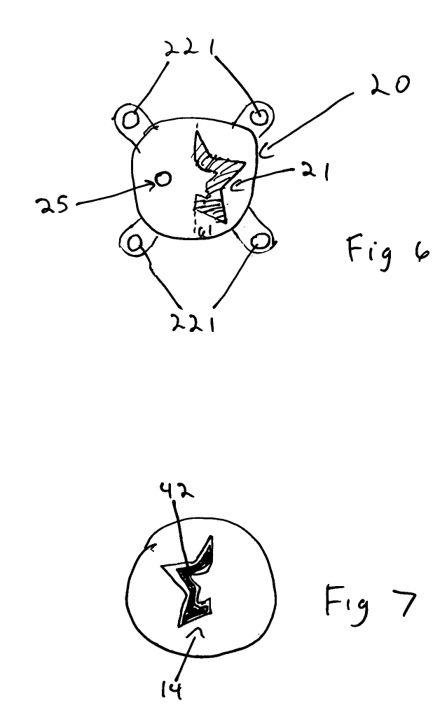

In FIG. 7, die 14 is designed to engage with cutter 21 and is shaped as a female version of cutter 21. A rubber or similar insert may be placed into the recesses of die 14 to block all but the deepest portions of cutter 21 from entering die 14. This ensures that a perforated partial outline 62 is as thin as possible.

In an alternate embodiment, both cutter 21 and die 14 can be shaped to produce a series of concentric partial cutouts 64A by perforating one partial outline within the interior of the shape defined by the outer partial outline. The area defined by the partial inner outline may or may not be folded over the axis of symmetry 61 common to both outlines. For the best decorative effect, no two areas defined by adjacent outlines should be folded together over the axis of symmetry 61, however the invention is not limited in this respect.

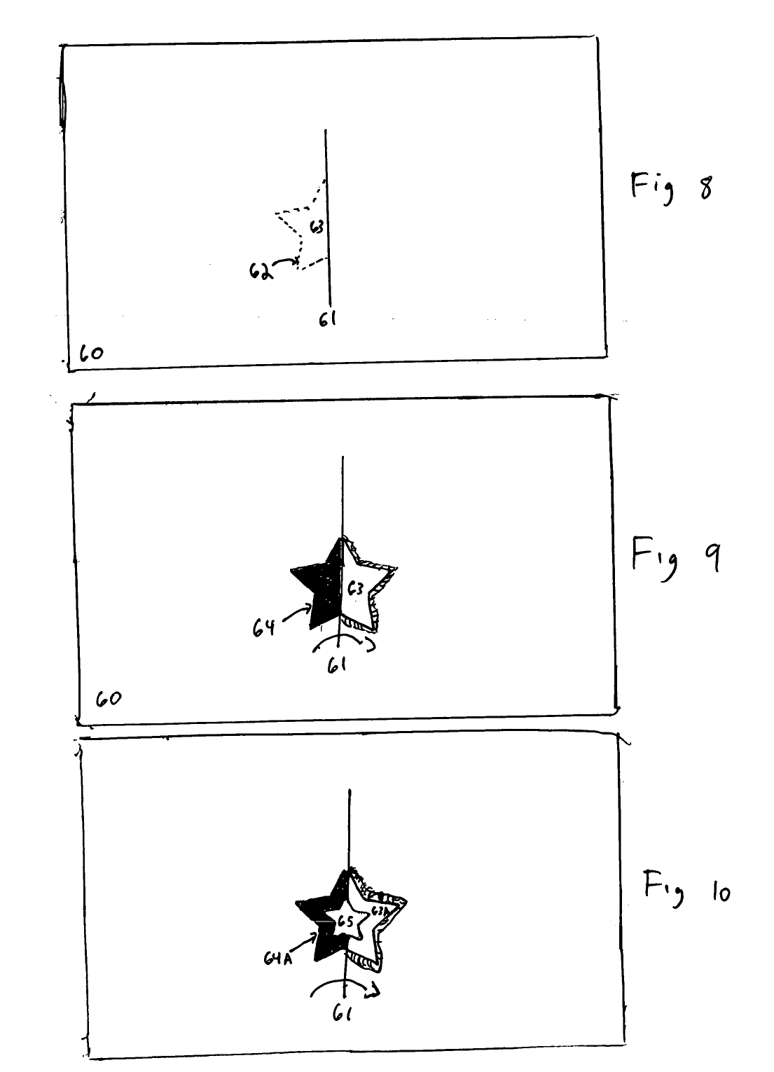

FIG. 8 shows sheet medium 60 in an overhead view before use by the present invention. Partial outline 62 to be perforated by the present invention is exactly one half of the desired shape as defined by axis of symmetry 61. Element 63 is the area of the sheet medium to be folded along axis of symmetry 61 to achieve the intended decorative effect as shown in FIG. 9.

FIG. 9 shows sheet medium 60 after area 63 has been folded over axis of symmetry 61. The desired shape can now be perceived as a combination of hollowed-out portion 64 and the folded over area 62. In addition, folded over portion 63 may protrude from the surface of sheet medium 60 at an angle to produce a three dimensional effect.

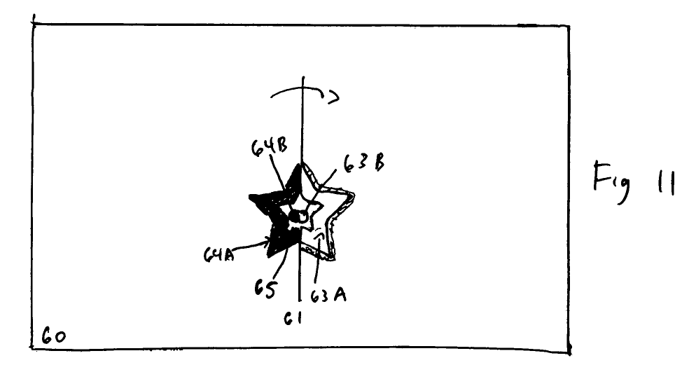

FIG. 10 shows an alternate embodiment in which one partial cutout can be embedded within the perimeter of another for an enhanced decorative effect. As in FIG. 10, area 63A is folded over axis of symmetry 61. However, half of area 65 is cut out of area 63A before it is folded, creating the appearance of a second complete shape formed by the inner outlines of hollowed out area 64A and folded over area 63A. This effect is achieved by adding a second concentric cutting edge to cutter 21.

FIG. 11 shows how this process can be repeated with two folded over regions to create the effect of three distinct shapes.

It is to be understood that the above description and drawings are only used for illustrating one embodiment of the present invention, not intended to limit the scope thereof. Any variation and derivation from the above description and drawings should be included in the scope of the present invention.

1. A punch for making a decorative design on a sheet media, said punch comprising:
a body formed with a fissure for receiving said sheet media,
a cutter axially movable within said body,
a die secured in said body configured to engage with said cutter,
wherein said cutter cuts along half of a first outline of a certain shape as defined by a center axis of symmetry to produce a partial cutout.

2. A punch as defined by claim 1, wherein the portion of said sheet medium circumscribed by said half of said first outline can be folded over said center axis of symmetry to achieve the effect of a completed said certain shape.

3. A punch as defined by claim 2, wherein said completed said certain shape has a hollow portion and a raised portion relative to said sheet medium.

4. A punch as defined by claim 1, wherein a second outline of a second certain shape is defined within said first outline.

5. A punch as defined by claim 3, wherein said second outline of said second certain shape is created by an inner cutting edge on said cutter.

6. A punch as defined by claim 1, wherein the cutting edge on said cutter tapers off relative to the distance to said axis of symmetry.

7. A punch as defined by claim 1, further comprising a pressing lever coupled with a cutting block affixed to said cutter.
